(19) United States
(12) Patent Application Publication
(10) Pub. No.: US 2024/0283046 A1
(43) Pub. Date: Aug. 22, 2024

(54) COOLING SYSTEM AND METHOD FOR BATTERY CELLS

(71) Applicant: Villanova University, Villanova, PA (US)

(72) Inventors: Sylvie Lorente, Philadelphia, PA (US); Sahin Gungor, Izmir (TR); Giovani Dambros Telli, Philadelphia, PA (US)

(73) Assignee: Villanova University, Villanova, PA (US)

(21) Appl. No.: 18/442,258

(22) Filed: Feb. 15, 2024

Related U.S. Application Data
(60) Provisional application No. 63/485,721, filed on Feb. 17, 2023.

(51) Int. Cl. H01M 10/613; H01M 10/625; H01M 10/653; H01M 10/6555; H01M 10/6557

(52) U.S. Cl. CPC H01M 10/613; H01M 10/625; H01M 10/653; H01M 10/6555; H01M 10/6557; H01M 2220/20

(57) ABSTRACT

A battery module is provided. The battery module may comprise a first battery cell of a plurality of battery cells, a second battery cell of the plurality of battery cells, and a heat transfer insert. The heat transfer insert is inserted between the first battery cell and the second battery cell, and is configured to thermally conduct heat from the first battery cells and the second battery cell. The battery module may further comprise a cold plate, coupled to the first heat transfer insert. The cold plate may be configured to transfer the heat from the heat transfer insert to an exterior environment of the battery module.

### CROSS-REFERENCE TO RELATED APPLICATIONS

This application claims priority to U.S. Provisional Patent Application No. 63/485,721, filed Feb. 17, 2023, the entirety of which is incorporated herein by reference.

### FIELD

This application generally relates to systems and methods for intra-module and inter-cell battery cooling techniques. More specifically, this disclosure pertains to utilizing flowing coolant and highly-thermally-conductive plates to transfer heat out of a battery module.

### BACKGROUND

Examples of stationary battery energy storage systems include rooms (or other areas) containing racks of containing modules (cases) with battery cells. Each battery cell generates heat during the charging and discharging phases. A stationary battery energy storage system can be the interface between the grid and, for example, an electrical vehicle or other device. The storage system can be charged from the grid and discharged into the electrical vehicle. Configurations also exist where the electrical vehicles charges the stationary battery energy storage system. Heat generated during charging and discharging must be removed.

Battery cells within a battery energy storage system (BESS) have a desired operating temperature at which the battery can operate at peak performance. Reduced performance can manifest as slower cell charging or discharging, or can manifest as energy inefficiency (e.g., higher wattages or watt-hours required in order to achieve a given watt-hour charge capacity or a given watt discharge rate or watt-hour discharge volume.) Heat, particularly heat produced by battery cells, can move the battery cells, modules, and the BESS out of the desired operating temperature, resulting in reduced performance of those components.

Heat is not instantaneously distributed throughout the battery module. Rather, heat is generated from within individual battery cells of the battery module, and generally must be drawn out from the periphery of the battery module. However, as the heat is both non-uniform in density and being generated from within the battery module, a typical cooling system implemented on the periphery of the battery module will result in warmer elements (e.g., battery cells) further from the periphery. This problem of warmer battery cells towards the center of the battery module is compounded when battery cells are stacked multi-dimensionally within a battery module: battery cells near the periphery will emit heat into the periphery, but will also emit heat into the battery cells furthest from the periphery (e.g., closest to the center). Due to this additional heat emitted from the relatively-peripheral battery cells, the central battery cells will experience heat disproportionate to the energy they produce, further degrading their performance. This further degraded performance results in slower or less-efficient energy production from the central battery cells, or even higher heat production from the central battery cells as those central battery cells attempt to overcome the heat burden being placed upon them by the battery cells closer to the periphery.

This disproportionate and compounding heat effect on the more-central battery cells in a battery module is material for at least two reasons. First, the more-central battery cells are likely to degrade faster as these battery cells experience and attempt to overcome their experienced heat. In many implementations, battery cells are unitary within a battery module, meaning, battery cells cannot be replaced or repaired separately from their sibling cells, or from the battery module itself. A burned-out battery cell will either sit idle within the battery module, permanently reducing the total effectiveness of the battery module, or may completely disable the battery module, necessitating repair or replacement of the battery module.

Second, a battery module, which generally has all of its respective battery cells wired in series or parallel without any or few controllable switches between those battery cells, can only perform as well as its worst-performing battery cell. Thus, if the heat burden on the most-central battery cell only allows charging at a rate of 11 kilowatts (kW) for that most-central battery to remain within the desired operating temperature, all of the battery cells of that battery module can only charge at a rate of 11 kW, even if the respective positions of those battery modules near a periphery allow for faster charging, such as at a rate of 17 kW. Similarly, if the most-central battery degrades to an extent such that it can only store 1 kW-hour (kWh), then all of the battery cells can each only charge until that most-central battery reaches 1 kWh of stored energy, even if the more-peripheral battery cells could charge longer and store more energy.

### SUMMARY

In accordance with some embodiments, a battery module is provided. The battery module may comprise a first battery cell of a plurality of battery cells, and a second battery cell of the plurality of battery cells. The battery module may also comprise a first heat transfer insert, inserted between the first battery cell and the second battery cell. The first heat transfer insert can be configured to thermally conduct heat from the first battery cell and the second battery cell. The battery module may further comprise a coolant channel, coupled to the first heat transfer insert. The coolant channel may be configured to transfer the heat from the heat transfer insert into an exterior environment of the battery module.

The above and other features of the present invention will be better understood from the following detailed description of the preferred embodiments of the invention that is provided in connection with the accompanying drawings.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a see-through view of an embodiment of a battery module with battery cells, liquid cooling channels at the module bottom and with high thermal conductivity inserts between some cells.

FIG. 2 is a side cross-sectional view of an embodiment of a battery module with battery cells, liquid cooling channels at the module bottom and with high thermal conductivity inserts between cells.

FIGS. 3A and 3B are an end cross-sectional view of embodiments of battery modules.

FIG. 4 is a see through view of an embodiment of a battery module with battery cells, liquid cooling channels at the module bottom and with high thermal conductivity inserts between some cells.

FIG. 5 is a see through view of an embodiment of a battery module with battery cells, liquid cooling channels at the module bottom and top and with high thermal conductivity inserts between some cells.

FIG. 6 is a side cross-sectional view of an embodiment of a battery module with battery cells, liquid cooling channels at the module bottom and with high thermal conductivity inserts between some cells.

FIG. 7 is a side cross-sectional view of an embodiment of a battery module with battery cells, liquid cooling channels at the module bottom and top and with high thermal conductivity inserts between some cells.

FIG. 8 illustrates the temperature distribution in various locations from a simulation of the battery module of FIG. 5.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In this description, relative terms such as “horizontal,” “vertical,” “up,” “down,” “top,” “bottom,” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both moveable or rigid attachments or relationships, unless expressly described otherwise. The term “operatively coupled” is such an attachment, coupling, or connection that allows the pertinent structures to operate as intended by virtue of that relationship. The term “coupled” refers to any thermal, electrical, logical, or physical connection, link or the like by which signals, energy, or information produced or supplied by one element are imparted to another element. Unless described otherwise, coupled elements or devices are not necessarily directly connected to one another, and may be separated by intermediate components, elements, or media that may modify, manipulate, or carry the signals, energy, or information.

As used herein, the term “substantially” denotes elements having a recited relationship (e.g., parallel, perpendicular, aligned, etc.) within acceptable manufacturing tolerances. For example, as used herein, the term “substantially parallel” is used to denote elements that are parallel or that vary from a parallel arrangement within an acceptable margin of error, such as +/−5° or 5%, although it will be recognized that greater and/or lesser deviations can exist based on manufacturing processes and/or other manufacturing requirements.

As used herein, the phrase “liquid coolant”, unless described otherwise, refers to liquid coolant, vapor coolant, cooling liquid, or cooling vapor. In particular, when utilizing a two-phase cooling system, the liquid coolant may change states one or more times within the method, apparatus, or a connected system such as heat exchanger pump. It is contemplated that the liquid coolant may contain solute or suspensions, and may briefly or for extended periods of time enter a solid state within one or more elements of the method or apparatus.

Various embodiments disclosed herein can be used in a battery energy storage system (BESS) in order to disperse or displace heat generated by battery elements. By utilizing both flowed coolant, as well as highly-thermally-conductive inserts, plates, or fins between the battery cells of a battery module, heat can be drawn out of the center of the battery module, allowing for a more uniform overall temperature within the battery module, and consequently a more uniform power storage and production profile across the battery cells in the battery module, as well as a longer lifespan of both the battery cells and the battery module. The inserts work in concert with the flowed coolant to transfer heat faster from the battery module—coolant or any substance has a specific heat capacity which effectively sets an asymptotic limit on the heat capacity rate of the coolant when flowed—flowing a coolant faster through a system will see diminishing returns on heat absorption, as the individual molecules of coolant will have less time to absorb heat before completing a cooling loop and returning to a heat exchanger. The inserts direct heat from the battery cells into a cold plate, which then directs heat into the coolant—rather than the heat plate or coolant needing to absorb heat from the ambient air within the battery module. By improving the heat flow through-line from battery cell to coolant, the coolant is able to more quickly absorb heat and approach a target temperature, thereby allowing for either a slower flow rate of coolant to absorb an equivalent amount of heat (thereby requiring a less intensive heat exchanger pump) or allowing for the same flow rate of coolant to absorb a greater amount of heat, presuming the coolant was not already heat-saturated when exiting the battery module.

While utilizing inserts in a battery module implementing coolant immersion is contemplated (e.g., the battery cells are immersed in a liquid coolant, which is flowed through the battery module) in embodiments where the electrical isolation between the liquid coolant and the battery cells cannot be ensured, and the danger or consequences of the liquid coolant conducting electricity with the battery cells are too high, electrical isolation between the liquid coolant and the battery cells is ensured by reliable intermediary components such as the inserts and a cold plate.

In embodiments, as described herein, thermal management is provided at the case/module scale and not at the cell level. That is, the complete electric integrity of the module is maintained by extracting the generated heat from a sealed case/module.

In embodiments, a stationary battery energy storage system includes a plurality of modules each including a plurality of battery cells, for example Li-ion battery cells. Charging and discharging of battery cells within stationary battery energy storage systems occurs through an electrochemical process within the Li-ion battery cells. The process is exothermic, with more heat being generated during discharge, and, depending on the cell capacity, often leads to cell temperatures and temperature differences through the cell beyond values acceptable for maintaining the integrity and life of the cells. This is even more crucial as the heat generated during the battery cell discharge increases with the discharge rate. Customers (for example, those charging electric vehicles) accept less and less long charging times for their vehicles, which necessitates increased discharge rates for the stationary battery energy storage systems. Thermal management of stationary battery energy storage systems is, therefore, necessary.

In embodiments, the stationary battery energy storage system is a large, e.g., room size, array of battery modules. In other embodiments, the stationary battery energy storage system can be part of smaller system, such as a charging station for an electric vehicle located at a home, office complex, grocery store or the like. In embodiments, the stationary battery energy storage system can be charged from the electric grid and/or alternative sources of power, such as solar panels, and/or the electric vehicle itself. In embodiments, the battery energy storage system is not stationary, e.g., it may be part of a mobile device such as an electric vehicle.

One approach to thermal management today is the use of air cooling techniques (e.g., the use of fans and blown air conditioning systems), but this approach lacks efficiency, is energy consuming and noisy.

Liquid cooling is another approach to thermal management of stationary (also referred to as “static”) energy storage systems; however liquid cooling has drawbacks. In one approach, liquid cooling is utilized at the battery cell level with cold plates, i.e. within the case of the battery module that contains the battery cells. However, in some instances this approach is not practical or permitted. Contact (and potential contact) between the liquid coolant and battery cell must be avoided to prevent short circuits and associated risks of fire and/or explosion. For this reason, liquid cooling must be performed at the module level, utilizing liquid cooling channels embedded within the battery module case. Most of the heat generated within the battery module is generated at the top of the battery cells. An air space exists between the top of the cells and the top of the case, which acts as a thermal insulation layer. Thus, the battery cells may be thermally insulated from the battery module via the air space. Such methods of thermal management may be acceptable for removing low levels of generated heat, but are not acceptable for higher levels of heat associated with elevated battery cell charging and discharging rates.

In embodiments, a cooling system for battery systems includes liquid cooling channels embedded either in the bottom wall of the battery module, or in the bottom and top walls of the battery module depending on the amount of heat to be extracted. The embedded liquid cooling channels are used in combination with high thermal conductivity inserts disposed in-between one or more of the battery cells. In embodiments, the high thermal conductivity inserts are formed from an electrically insulating material of high thermal conductivity (e.g. ceramics, such as Aluminum nitride). When disposed in the right places, the inserts convey generated heat towards the top of the battery module for removal via the liquid cooling channels.

In embodiments, the high thermal conductivity inserts are disposed adjacent to and between battery cells, and the high thermal conductivity inserts themselves do not have channels through which the liquid coolant circulates. This isolation between the high thermal conductivity inserts and the coolant liquid ensures that no liquid coolant can come in contact with the battery cells, e.g., in the case of breakage, cracking or other damage, wear or fatigue in the high thermal conductivity inserts.

In embodiments, the liquid coolant channels embedded in or otherwise formed in the bottom wall of the battery module can effectively cool approximately the bottom half of the battery cells' height. The high thermal conductivity inserts provide thermal management for the top half of the battery cells' height. Depending on the amount of heat generated, additional liquid cooling channels may be provided in the top wall of the battery module, in order to remove heat conducted to the top of the module by the high thermal conductivity inserts.

In embodiments, liquid cooling is efficiently provided at the scale of the modules without compromising the integrity of the modules due to the battery cells within the module never coming into contact with the liquid coolant.

Excessive temperatures within a battery cell environment can adversely affect the electrochemical process within the battery cell, thus affecting the health of the battery cell and the battery cell's longevity. In embodiments, the amount of cooling provided is sufficient to ensure that under a given charging and/or discharging rate producing a certain amount of heat, the battery cell temperature is maintained under a temperature threshold deemed acceptable for the health and/or longer-term safety of the battery cell. In embodiments, the system is configured such that the battery cell does not exceed a maximum temperature (Tₘₐₓ) measured for example on the surface of the battery cell or within the battery cell. The maximum temperature depends on the application and on the type of battery cell. In one embodiment, the maximum temperature is 30° C. (86° F.),

Alternatively or additionally, in embodiments, the amount of cooling provided is sufficient to ensure that under a given charging and/or discharging rate producing a certain amount of heat, the battery cell temperature delta across the battery cell, (e.g., between the bottom and the top of the battery cell,) is maintained within a temperature threshold delta deemed acceptable for the health and/or longer term safety of the battery cell. In embodiments, the system is configured such that the battery cell temperature delta (ΔT) is less than a temperature threshold delta of 6° C. (10.8° F.) though it should be appreciated that the maximum temperature difference depends on the application and type of battery cell.

While embodiments are described in connection with stationary battery Li-ion energy storage, it should be appreciated that the thermal management approach described herein is applicable to other kinds of batteries that generate heat during charging and/or discharging, such as (stationary or non-stationary) Li-ion, metal-air, post lithium and any other battery systems.

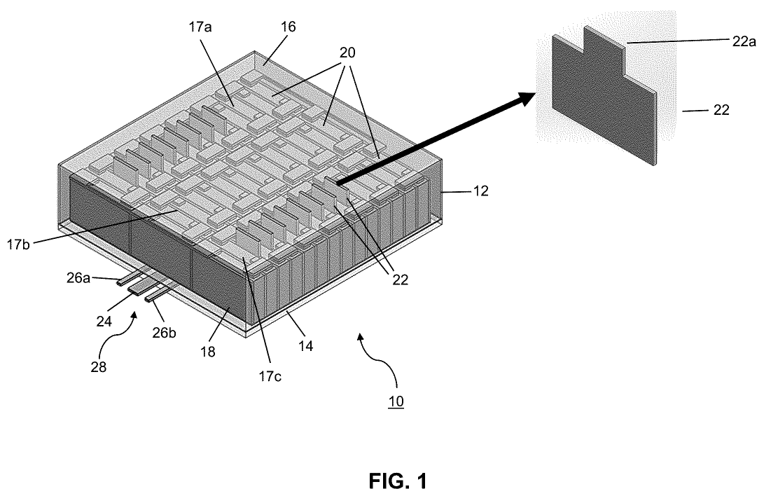

FIG. 1 is a see-through view of an embodiment of a battery module 10. The battery module 10 includes a frame or case 12 with bottom wall 14, top wall 16 and side walls 18. In embodiments, the frame or case 12 is constructed of steel or other rigid material. In embodiments, bottom wall 14 and/or top wall 16 constitute a cold plate configured as a heat transfer interface to a fluid (e.g., a coolant or air). In embodiments, the cold plate, or any portion of bottom wall 14 or top wall 16 constituting a cold plate can be made of extruded metal. In embodiments, the extruded metal is high in thermal conductivity, while the electrical conductivity is immaterial, though preferably the electrical conductivity is low to further reduce any risk of electrical conduction between a liquid coolant and battery cells 20.

The module 10 includes battery cells 20 disposed in the frame or case 12. In the illustrated embodiment, the battery cells 20 are arranged in three rows (17a, 17b, 17c) of cells 20, with fourteen cells in each row (for a total of forty-two cells 20 in the battery module 10). The battery cells 20 may be wired in any arrangement, order, or sequence: battery cells 20 may be wired in series, or in parallel; battery cells 20 in a given row 17a may be wired together in series, while rows 17a, 17b, 17c are wired to each other in parallel. Battery cells 20 may be wired non-sequentially e.g., battery cells 20 which are physically proximate may not be wired together or may be indirectly wired together, and battery cells 20 which have physically intervening battery cells 20 may nevertheless be directly wired together.

It is to be appreciated that this disclosure provides particular (but not exclusive) benefits to battery cells 20 wired in series: battery cells 20 wired in series sum their voltages, thereby producing a relatively high voltage as compared to the voltage ratings of individual battery cells 20. High voltage is preferred in charging applications, as in general a charged device requires the largest amount of energy delivered in the shortest amount of time, without concern for how much energy drain the battery module 10 experiences. Therefore, charging applications benefit less from the consistent energy output over an extended period of time, a feature provided by battery cells 20 wired in parallel. However, battery cells 20 wired in series are particularly dependent upon the consistent output of their other battery cells 20 in order to produce high overall voltage. This interdependency highlights the need for consistent voltage output across the entire battery module 10; and as voltage consistency is affected by non-nominal temperatures, consistent voltage output benefits from the disclosed material, which allows for improved temperature consistency across a battery module 10.

Liquid cooling channels 28 (described in more detail below) are formed in or otherwise disposed in the bottom wall 14 constituting a cold plate under the battery cells 20. In embodiments, battery cells 20 in contact with or proximate to bottom wall 14, in particular but not exclusively when top wall 16 constitutes a cold plate, are understood to be battery cells 20 thermally directly connected to top wall 16. Battery cells 20 not in contact with and not proximate to top wall 16 are understood to be battery cells 20 thermally indirectly connected to top wall 16. In embodiments, battery cells 20 in contact with or proximate to bottom wall 14, in particular but not exclusively when bottom wall 14 constitutes a cold plate, are understood to be battery cells 20 thermally directly connected to bottom wall 14. Battery cells 20 not in contact with and not proximate to bottom wall 14 are understood to be battery cells 20 thermally indirectly connected to bottom wall 14.

High thermal conductivity inserts 22 are disposed between some adjacent battery cells 20. In embodiments, the inserts 22 comprise high thermal conductivity dielectric plates (such as formed from Aluminum nitride or other ceramic material) disposed between adjacent battery cells 20. In the illustrated embodiment, highly thermally conductive inserts are disposed between each adjacent pair of battery cells in each of rows, 17a, 17b and 17c of battery cells, but the inserts 22 (shaped as shown in the figure with a top raised portion 22a that extends above the height/upper surface of the battery cells 20) are included only in between some adjacent pairs of battery cells 20 in the first and third rows 17a, 17c of battery cells. That is, in the illustrated embodiment, only a subset of the inserts are inserts 22 that include a top raised portion 22a and therefore extend above the battery cells 20 to be in contact with or proximate to the top wall 16 of the case 12. In embodiments, inserts 22, in particular but not exclusively inserts 22 with a top raised portion 22a, in contact with or proximate to top wall 16, in particular but not exclusively when top wall 16 constitutes a cold plate, are understood to be inserts 22 thermally directly connected to top wall 16. Inserts 22 not in contact with and not proximate to top wall 16 are understood to be inserts 22 thermally indirectly connected to top wall 16. In embodiments, the liquid cooling channels 28 include a central cooling liquid inlet 24 and first and second cooling liquid outlets 26a and 26b. Though not shown, it should be understood that the liquid cooling inlet 24 and outlets 26a, 26b are connected to a pump system for circulating the liquid coolant. In embodiments, heat can be removed from the liquid coolant by passing it through a heat exchanger.

In embodiments, the thermally conductive insert 22 is shaped generally to match the shape of the side wall of a battery cell 20 adjacent to which it is disposed, so as to maximize the surface area available for heat transfer from the battery cell 20 to the thermally conductive insert 22. In embodiments, the thermally conductive insert 22 also includes a raised portion 22a (as shown in FIG. 1) that extends above the battery cell so as to dissipate heat into the area above the battery cell 20 and below or to the top wall 16 of the case 12.

In the embodiment of FIG. 1, liquid cooling channels 28 underlying the battery cells 20 principally remove heat from the bottom half of the battery cells 20. Inserts 20 are positioned adjacent to the body of the battery cells 20 and extend above the top of the battery cells 20. Heat is conducted from the battery cells 20 through the inserts 22 to the space between the top of the battery cells 20 and the top wall 16 of the case 12. In this embodiment, the liquid cooling channels 28 are arranged in pattern resembling fingers branching, called canopy-to-canopy, from the central inlet 24 to underlie the battery cells 20. It should be appreciated that the liquid coolant is at its coolest at the central inlet 24, which extends underneath the central row 17b of battery cells 20 to the end of the central row 17b, before branching laterally to the first and third rows 17a, 17c of battery cells 20. In embodiments, inserts 22 are not utilized between battery cells 20 in this central row 17b, as the liquid coolant in combination with convection to the air in space 38 between the central row 17b of battery cells 20 and the top wall 16, is sufficient to maintain the battery cells 20 in the central row 17b within proper temperature tolerances. However, as the liquid coolant continues through the liquid cooling channels 28 that underlie the first and third rows of cells 20, progressing toward the outlets 26a, 26b, the liquid coolant is less effective at removing heat (as the temperature of the coolant increases). As such, the inserts 22 are located between the battery cells 20 closest to the outlets 26a, 26b.

Space 38 may be filled with air, but space 38 may be allocated or contain wiring or control mechanisms for operation of battery module 20, which can be called the contents of space 38. In embodiments, the contents of space 38 may have minimal, varying, or unknown thermal or electrical conductive or insulating properties. The contents of space 38 may, in the design of some embodiments, be assumed to have thermal and electrical conductive or insulating properties similar to air. In the design of some other embodiments, the contents of space 38 may be assumed to be very electrically conductive, and very thermally insulating.

It should be appreciated that the configuration of the liquid cooling channels 28 can be adapted depending on the amount of heat to be removed, the arrangement of the battery cells and the module or case and, as such, the arrangements of the liquid cooling channels 28 illustrated herein are non-limiting.

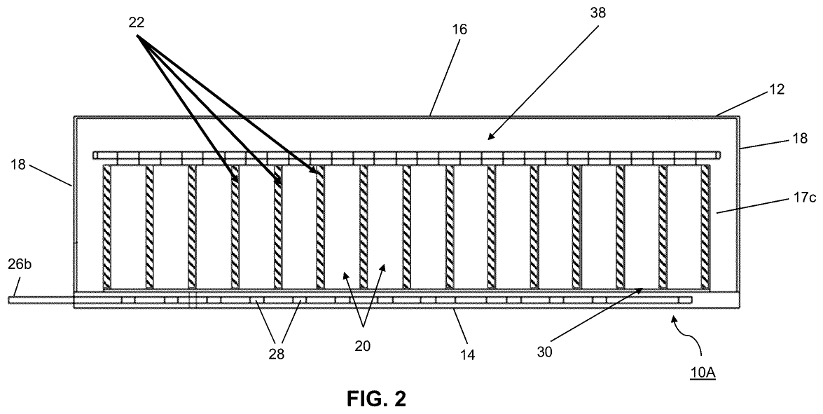

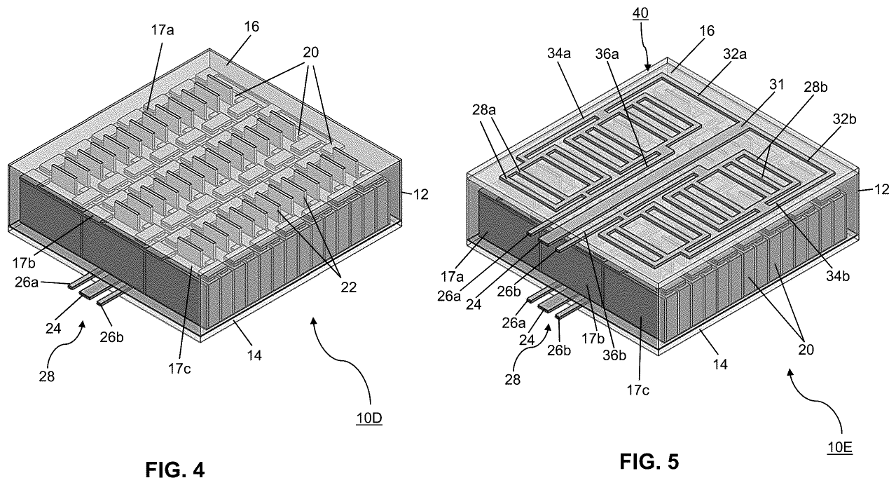

FIG. 2 is a side cross-sectional view of an embodiment of a battery module 10A, including battery cells 20, liquid cooling channels 28 at the battery module 10A bottom wall 14, and high thermal conductivity inserts 22 between certain battery cells 20. In the illustrated embodiment, fifteen thermal conductivity inserts 22 are provided in between and adjacent to fourteen battery cells 20 arranged in the row 17c. A similar arrangement is provided in row 17a. In embodiments, thermal conductivity inserts 22 may also be provided in row 17b, as illustrated in, for example, the embodiment of FIG. 4. Lateral liquid cooling channels 28 for liquid coolant are shown underlying the battery cells 20 in row 17c. In embodiments, the battery cells 20 may be disposed on a thermal interface material layer 30 disposed on the top surface of bottom wall 14 of the case 12. Thermal interface materials (TIMs) are used in electronics to transfer heat away from hot components to cooling hardware. TIMs are designed to fill in air gaps, which act as thermal insulation, to provide for improved heat transfer, lower thermal resistance, and overall better cooling of the electronic.

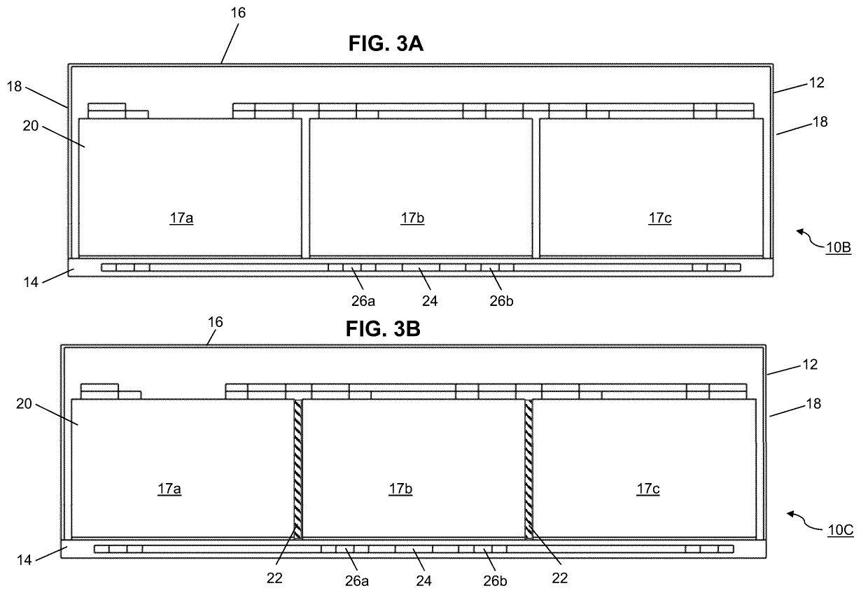

FIG. 3A is an end cross-sectional view of an embodiment of battery module 10B. In this embodiment, there are no thermal conductivity inserts disposed between adjacent rows 17a, 17b and 17c of battery cells 20. FIG. 3B is an end cross-sectional view of one embodiment of battery module 10C. In this embodiment, thermal conductivity inserts 22 are disposed between adjacent rows 17a and 17b of battery cells 20 and between adjacent rows 17b and 17c of battery cells 20.

FIG. 4 is a see through view of an embodiment of a battery module 10D with battery cells 20, liquid cooling channels 28 formed in the bottom wall 14 of the battery module 10D, and with high thermal conductivity inserts 22 between and adjacent to battery cells 20. In embodiments, inserts 22 in contact with or proximate to bottom wall 14, in particular but not exclusively when bottom wall 14 constitutes a cold plate, are understood to be inserts 22 thermally directly connected to bottom wall 14. Inserts 22 not in contact with and not proximate to bottom wall 14 are understood to be inserts 22 thermally indirectly connected to bottom wall 14. In the illustrated embodiment, fifteen inserts 22 are provided for each row 17a, 17b, 17c. Thirteen inserts 22 of the fifteen inserts 22 per row 17a, 17b, 17c include raised portions 22a, and are disposed between each adjacent pair of battery cells 20. Two inserts 22 of the fifteen inserts 22 per row 17a, 17b, 17c do not include raised portions 22a, and are disposed at the beginning and end of each row 17a, 17b, 17c and adjacent to a battery cell 20. The three rows 17a, 17b, 17c, each of thirteen inserts 22a including raised portions 22a and two inserts not including raised portions 22a at either end of each row 17a, 17b, 17c, result in a total of forty-five inserts 22 in the battery module 10D. In certain embodiments, inserts 22 may or may not be disposed at one or both ends of each row 17a, 17b, 17c.

FIG. 5 is a see through view of an embodiment of a battery module 10E with battery cells 20, liquid cooling channels 28 formed in the bottom and top walls 14, 16 of the module and with high thermal conductivity inserts 22 between and adjacent to cells 20. FIG. 5 illustrates in more detail one exemplary arrangement of the liquid cooling channels 28 disposed in the top wall 16 of the case 12. It should be understood that in embodiments, a similar arrangement is used in the bottom wall 14 of the case 12. In the illustrated embodiment, liquid coolant enters a central channel 31 at intake 24. Central channel 31 runs over and along the length of the central row 17b of battery cells 20. Proximate to the end of the central row 17b, the central channel branches 31 into arms 32a, 32b to direct the liquid coolant laterally, and then the arms 32a, 32b branch again into distribution arms 34a, 34b that run parallel to the central channel 31. Liquid cooling channels or fingers 28a, 28b extend from the distribution arms 34a, 34b and overlie the battery cells 20. In the illustrated embodiment, ten liquid coolant channels 28a are fed from distribution arm 34a and ten liquid cooling channels 28b are fed from distribution arm 34b. Liquid cooling channels 28a are then connected to return liquid cooling channel 36a connected to first outlet 26a, and liquid coolant channels 28b are connected to return channel 36b connected to second outlet 26b.

Only one exemplary arrangement for the coolant system 40 disposed in top wall 16 and bottom wall 14 of the case 12 is shown in FIG. 5, and other arrangements can be used. It should be appreciated that the arrangement of the coolant system 40 is designed to remove sufficient amounts of heat to maintain the battery cell 20 temperature and temperature delta within tolerances (e.g., the maximum temperature and the temperature threshold delta) for a given battery cell 20 discharge and/or charge rate. Considerations for the arrangement include, for example, the liquid coolant type, temperature, and flow rate; the coolant liquid channel size and location (both in terms of its location in one or both of the top and bottom walls and its location in the walls vis a vis the battery cells); the number of channels; the insert material and its dielectric and thermal conductivity properties, number, and arrangement; and the module size and free space. It should also be appreciated that the liquid cooling channels 28a, 28b, 31, 32a, 32b, 34a, 34b need not be of uniform size. For examples, larger channels (and thus more coolant) may be used more in areas further away from the inlet 24, in recognition that the temperature of the liquid coolant will increase as the liquid coolant removes heat from the environment.

In embodiments, in order to distribute the heat more evenly, a counter flow configuration is chosen, both for the bottom cooling channels 28 and for the top cooling channels 28. Thus, the liquid cooling channels 28 driving the warmed liquid coolant to the exit are right next to or most proximate the inlet channel 24 that flows the liquid coolant in. The inlet channel 24 bifurcates into two subnetworks once reaching the opposite side of the case. In certain embodiments, the subnetworks are made in the example presented here of two different architectures of parallel liquid coolant channels. While the heat generated at the level of the bottom of the battery cells 20 is uniformly distributed, the relative location of the coolant channels has impact on the ability to extract the heat because the fluid temperature changes with the location. Therefore, the mass flow rate that enters into one or the other block of parallel channels is controlled by choosing the block entrance cross section, allowing to better control the heat exchanges.

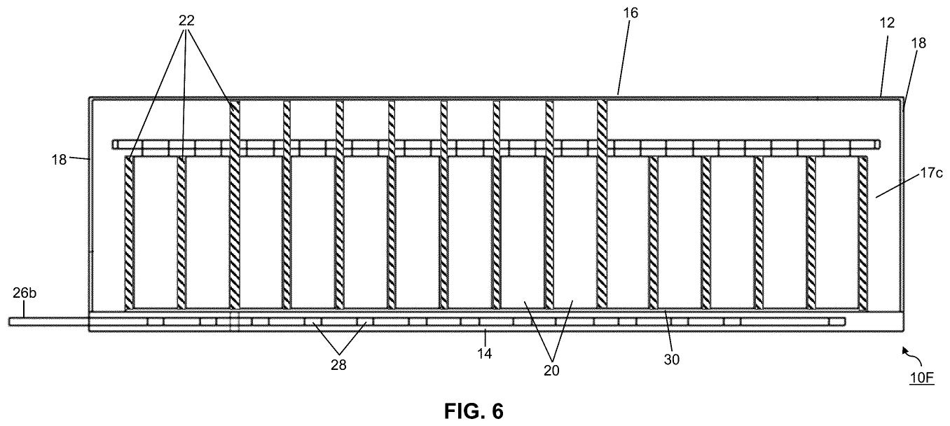

FIG. 6 is a side cross-sectional view of an embodiment of a battery module 10F with battery cells 20, liquid cooling channels 28 at the battery module 10F bottom wall 14 and with high thermal conductivity inserts 22 disposed between and adjacent to battery cells 20. This embodiment is identical to the embodiment of FIG. 2 except that at least some of the inserts 22 extend in height above the height of the battery cells 20 into the air space 38 above the cells 20 and to or proximate to the top wall 16 of the case 12.

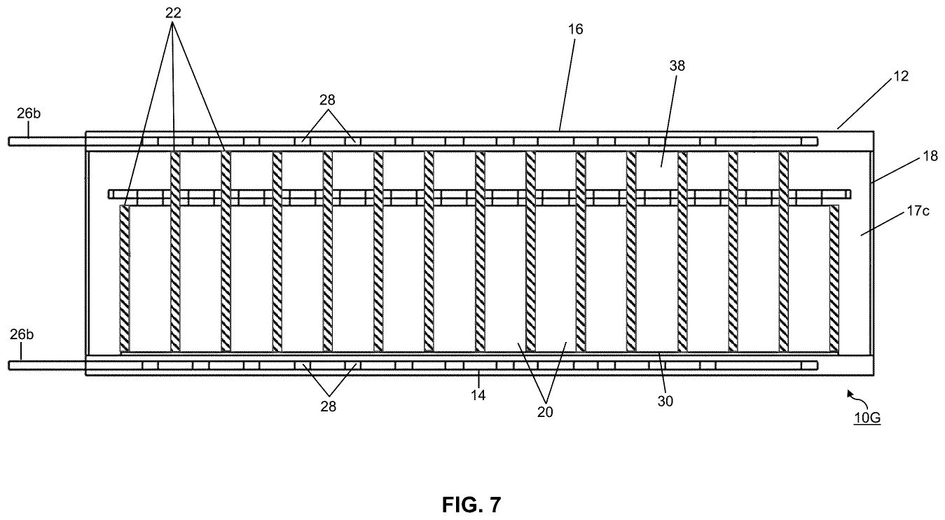

FIG. 7 is a side cross-sectional view of an embodiment of a battery module 10G with battery cells 20, liquid cooling channels 28 at the module bottom wall 14 and top wall 16 and with high thermal conductivity inserts 22 disposed between and adjacent to battery cells 20. As shown in this embodiment, each insert 22 that is disposed between an adjacent pair of battery cells 20 extends in height above the height of the battery cells 20 into the air space 38 above the cells 20 and to or proximate to the top wall 16 of the case 12. Inserts 22 disposed at the ends of a battery cell row 17c have heights at or about equal to the height of the battery cells 20.

In embodiments, the liquid coolant is a mixture of water and ethylene-glycol used in batteries for cooling.

In embodiments, the thermal conductivity inserts 22 are highly thermally conductive, having a thermal conductivity of at least 200 W/mK. In embodiments, the thermal conductivity inserts 22 are formed from high thermal conductivity dielectric, which highly thermal conductive has a thermal conductivity of 200 W/mK.

In embodiments, the thermal conductivity insert 22 is also electrically insulating, having a dielectric constant of at least around 9. Aluminum nitride has a dielectric constant of 9. Other ceramics may also be used, such as silicon carbides, or silicon nitride, epoxy matrix composites and other composite materials.

Simulations were conducted to evaluate heat removal and battery cell temperature under the following scenarios:

Case One: Sixteen (16) total high thermal conductivity dielectric plates, each 5 mm thick and shaped (i.e., with a raised portion 22a extending above the battery cell 20 height) and located as shown in FIG. 1 located only in rows 17a and 17c (i.e., two rows 17a, 17c each of eight inserts 22), with a Reynolds number at the inlet equal to 2,000. Shorter high thermal conductivity dielectric plate inserts 22 are disposed between other adjacent pairs of battery cells (i.e., inserts 22 without a raised portion 22a that extends above the battery cell 20 height). It should be appreciated that the Reynolds number is a non-dimensional parameter used in fluid mechanics to determine if the flow of a fluid (e.g., the liquid coolant) is laminar or turbulent. In this case, the flow is laminar.

Case Two: Sixteen (16) total high thermal conductivity dielectric plate inserts 22, each 5 mm thick and shaped and located as shown in FIG. 1 only in rows 17a and 17c (i.e., two rows 17a, 17c each of eight inserts 22), with a Reynolds number equal to 1000.

Case Three: Forty-Five (45) total high thermal conductivity dielectric plate inserts 22, each 5 mm thick and shaped and located as shown in FIG. 4 in rows 17a, 17b and 17c (i.e., three rows 17a, 17b, 17c each of fifteen inserts 22), with a Reynolds number equal to 2000.

Case Four: No inserts 22 as shaped in FIG. 1 (having the raised portion 22a) in any rows and top and bottom cooling arranged similarly to as shown in FIG. 5 (i.e., three rows 17a, 17b, 17c each of fifteen inserts 22, with none of the inserts 22 including a raised portion 22a) with a Reynolds number equal to 2000.

Case Five: Sixteen (16) total high thermal conductivity dielectric plate inserts, each 5 mm thick and shaped and located as shown in FIG. 1 (i.e., two rows 17a, 17c each of eight inserts 22), and top and bottom cooling as shown in FIG. 5 with Reynolds number equal to 2000.

Case Six: Thirty-Nine (39) total high thermal conductivity dielectric plates, each 5 mm thick and shaped and located as shown in FIG. 4 and top and bottom cooling systems 40 as shown in FIG. 5 with a Reynolds number equal to 2000.

Case Seven: Twenty (26) total high thermal conductivity dielectric plates, each 5 mm thick and arranged similarly to as shown in FIG. 1 with thirteen (13) plates each in first and third rows 17a, 17c, and no plates that had the raised portions 22a, i.e., only shorter plates, in middle row 17b, and top and bottom cooling systems 40 as shown in FIG. 5 with a Reynolds number equal to 2000.

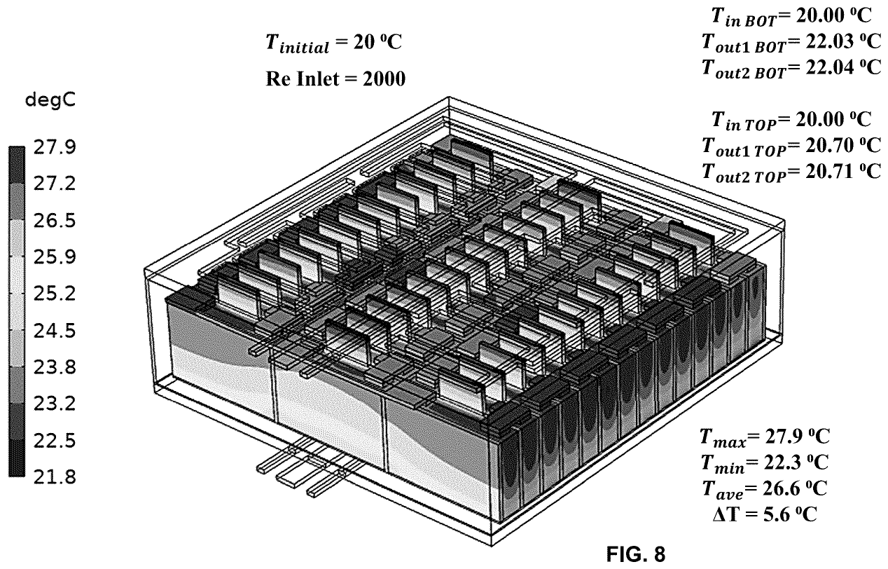

It should be appreciated that in some circumstances, the various cases described above may be sufficient to remove enough heat from the battery modules 10,10A-G. Simulation results for Case 6 are described below in connection with FIG. 8.

FIG. 8 illustrates the temperature distribution in various locations from a simulation (Case 6) of the battery module. This simulation assumed forty-five high thermal conductivity dielectric inserts 22, with fifteen inserts per row 17a, 17b, 17c. The fifteen inserts per row 17a, 17b, 17c include thirteen inserts 22 with raised portions 22a and two inserts 22 without raised portions 22a, with one of the inserts 22 without raised portions 22a at each end of each row 17a, 17b, 17c. The top and bottom cooling system 40 arranged like that of FIG. 5; the initial liquid coolant (water mixed with ethylene glycol) temperature of 20° C. at each inlet; a Reynolds number for the coolant flow of 2000; and discharge rate of 2 C (where C is the charging/discharging rate of the battery cells 20 relative to nominal capacity) after about 1758 s. The simulation showed that the temperature of the coolant at the bottom intake 24 was 20.00° C. and the temperatures at the first and second bottom outlets 26a, 26b were 22.03° C. and 22.04° C., respectively. The simulation showed that the temperature of the coolant at the top intake 24 was 20.00° C. and the temperatures at the first and second top outlets 26a, 26b were 20.70° C. and 20.71° C., respectively. The maximum temperature at a battery module 20 was 27.9° C. The minimum temperature at a battery module 20 was 22.3° C. The average temperature at a battery module 20 was 26.6° C. And the temperature delta between high and low temperatures at battery module 20 was 5.6° C. All temperatures were within the desired parameters for preserving battery health.

The numerical simulations indicate that it is possible to convey the heat generated during the charge/discharge processes by tailoring the inserts (number, location, shape, thermal properties) to the specific amount of heat to extract.

Although the subject matter has been described in terms of various embodiments, the disclosure should be construed broadly, to include other variants and embodiments, which may be made by those skilled in the art.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A battery module, comprising:
a first battery cell of a plurality of battery cells;
a second battery cell of the plurality of battery cells;
a first heat transfer insert, inserted between the first battery cell and the second battery cell, and configured to thermally conduct heat from the first battery cell and the second battery cell; and
a cold plate, coupled to the first heat transfer insert, and configured to transfer the heat from the heat transfer insert to an exterior environment of the battery module.

2. The battery module of claim 1, wherein:
the cold plate is configured to flow coolant.

3. The battery module of claim 2, wherein:
the cold plate is configured to use convection to transfer the heat from the first heat transfer insert to the exterior environment via the coolant.

4. The battery module of claim 2, wherein:
the coolant is electrically insulated from the first battery cell and the second battery cell.

5. The battery module of claim 2, wherein:
the first heat transfer insert is configured to directly thermally connect to the cold plate.

6. The battery module of claim 1, wherein:
the first battery cell and the second battery cell are indirectly thermally connected to the cold plate via the first heat transfer insert.

7. The battery module of claim 6, wherein:
the first battery cell and the second battery cell are only configured to be indirectly thermally connected to the cold plate.

8. The battery module of claim 1, further comprising:
a third battery cell of the plurality of battery cells;
a fourth battery cell of the plurality of battery cells; and
a second heat transfer insert, inserted between the third battery cell and the fourth battery cell, and configured to thermally conduct heat from the third battery cell and the fourth battery cell.

9. The battery module of claim 8, wherein:
the first and second battery cell are thermally insulated from the third and fourth battery cell.

10. The battery module of claim 8, further comprising:
a lateral heat transfer insert, inserted between:
a first row including the first battery cell and the second battery cell, and
a second row including the third battery cell and the fourth battery cell,
and configured to thermally conduct heat from the first battery cell, the second battery cell, the third battery cell, and the fourth battery cell.

11. The battery module of claim 8, wherein:
the first battery cell is electrically coupled in series to the second battery cell;
the third battery cell is electrically coupled in series to the fourth battery cell; and
the first battery cell is electrically coupled in series to the third battery cell.

12. The battery module of claim 1, further comprising:
a battery module case, the battery module casing enclosing the first battery cell and the second battery cell,
wherein:
the first battery cell and the second battery cell are thermally insulated from the battery module case.

13. The battery module of claim 1, wherein:
the battery module is configured to be placed within a battery energy storage system (BESS); and
the exterior environment is exterior to the BESS.

14. The battery module of claim 1, wherein:
the first battery cell includes a top surface;
the battery module includes a top wall;
the first heat transfer insert extends beyond the top surface toward the top wall.

15. A battery system, comprising:
a first row of battery cells of a plurality of rows of battery cells;
a second row of battery cells of the plurality of rows of battery cells;
a third row of battery cells of the plurality of rows of battery cells;
a casing, including:
a side wall,
a top wall, and
a bottom wall,
the plurality of rows of battery cells disposed within the casing,
the top wall or bottom wall configured as a cold plate;
a first heat transfer insert between a first battery cell of the first row of battery cells and a second battery cell of the first row of battery cells, the first and second battery cells being adjacent to one another in the first row of battery cells, the first heat transfer insert comprising an electrically insulating material of high thermal conductivity; and
a second heat transfer insert between a third battery cell of the third row of battery cells and a fourth battery cell of the third row of battery cells, the third and fourth battery cells being adjacent to one another in the third row of battery cells, the second heat transfer insert comprising the electrically insulating material of high thermal conductivity.

16. The cooling system of claim 15, wherein:
the electrically insulating material of high thermal conductivity includes a ceramic;
the ceramic includes aluminum nitride;
the top wall and tops of the plurality of rows of battery cells form a space; and
the first heat transfer insert extends into the space.

17. The cooling system of claim 15, wherein:
the cold plate includes a cooling liquid outlet;
the first battery cell is most proximate to the cooling liquid outlet of the first row of battery cells;
the first heat transfer insert is thermally directly connected to the first battery cell and the second battery cell.

18. The cooling system of claim 15, wherein:
the first battery cell includes a battery cell face;
the first heat transfer insert includes a heat transfer body face, the heat transfer body face substantially matching the battery cell body face, and the heat transfer body face is substantially fully in contact with the battery cell face.

19. The cooling system of claim 15, further comprising:
a battery module casing, the battery module casing configured to enclose the first battery cell and the second battery cell,
wherein:
the battery module casing is configured to be thermally insulated from the first battery cell and the second battery cell.

20. A method of cooling a battery module during charging and/or discharging a plurality of battery cells within the battery module, the method comprising:
thermally conducting heat from the plurality of battery cells into a heat transfer insert; and
transferring the heat from the heat transfer insert into an exterior environment via a cold plate.
